(19) United States
(12) Patent Application Publication
(10) Pub. No.: US 2025/0242451 A1
(43) Pub. Date: Jul. 31, 2025

(54) HYBRID ADDITIVE MANUFACTURING REPAIR WITH POWDER BED FUSION FEATURE AND DIRECTED ENERGY DEPOSITION JOINING

(71) Applicant: RTX Corporation, Farmington, CT (US)

(72) Inventors: Brendan Gustafson, East Hartford, CT (US); Peter Breitzmann, Aldie, VA (US)

(21) Appl. No.: 18/424,369

(22) Filed: Jan. 26, 2024

(51) Int. Cl. B23P 6/00; B22F 3/105; B22F 5/00; B22F 7/06

(52) U.S. Cl. CPC B23P 6/007; B22F 3/105; B22F 5/009; B22F 7/062; B22F 2007/068

(57) ABSTRACT

A method of weld repairing an original part includes inspecting the original part to identify a worn or defective feature requiring repair, removing from the original part the worn or defective feature requiring repair, fabricating a replacement feature, joining the replacement feature to the original part to complete a desired repair, and returning the original part to service after completion of the desired repair. The replacement part is made with a powder beam fusion (PBF) technique. The replacement feature is joined to the original part using a directed energy deposition (DED) joining technique The original part and replacement feature are made from a base material. The DED joining technique uses the base material to join the replacement feature to the original part

The present disclosure relates generally to repair of components and, more particularly, to an approach for combining additive manufacturing techniques to accomplish a repair.

It is often desirable to repair components used in a variety of applications, include aircraft propulsion applications, after they have suffered operations-related wear or damage due to use in the environments for which they were intended. While a variety of repair techniques are available, not all such components can be repaired using currently known techniques.

### SUMMARY

One aspect of this disclosure is directed to a method of weld repairing an original part including inspecting the original part to identify a worn or defective feature requiring repair, removing from the original part the worn or defective feature requiring repair, fabricating a replacement feature, joining the replacement feature to the original part to complete a desired repair, and returning the original part to service after completion of the desired repair. The replacement part is made with a powder beam fusion (PBF) technique. The replacement feature is joined to the original part using a directed energy deposition (DED) joining technique The original part and replacement feature are made from a base material. The DED joining technique uses the base material to join the replacement feature to the original part

Another aspect of this disclosure is directed to an original part repaired using a hybrid repair process. The original part made from a base material and a replacement feature made using a powder beam fusion (PBF) technique from the base material is joined to the original part using a directed energy deposition (DED) joining technique.

### BRIEF DESCRIPTION OF THE DRAWINGS

FIG. 1 is a schematic representation of a gas turbine engine stator vane ring.

FIG. 2 is a schematic representation of a part repaired with the method of this disclosure.

FIG. 3 is a flowchart of the repair process of the present disclosure.

### DETAILED DESCRIPTION

While a wide variant of repair techniques are available for components that have suffered operations-related wear or damage due to use in the environments for which they were intended, not all components can be repaired using currently know techniques. Currently there is a focus on using various additive manufacturing (AM) techniques to perform repairs. For example, when a repair involves removal and replacement of material, the replacement material can be made using powder bed fusion (PBF) techniques such a powder bed fusion-laser (PBF-L) or powder bed fusion-electron beam (PBF-EB). One advantage of making replacement material with PBF techniques is that the replacement material can be made to near net shape such that the replacement material may, at most, require only limited machining before use.

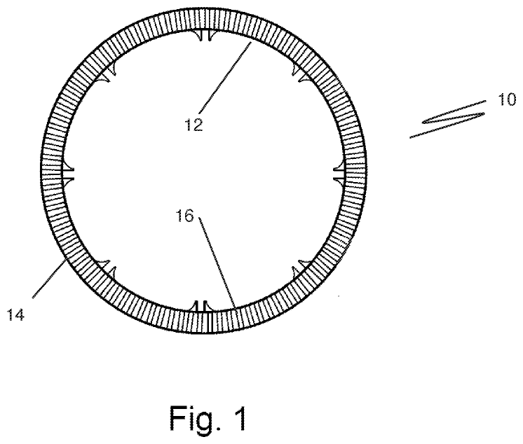

As a non-limiting example, FIG. 1 shows a stator ring 10 from a gas turbine engine (not shown). As known in the art gas turbine engines use stator rings to direct airflow through the gas turbine engine compressor and turbine sections (not shown). The stator ring 10 includes an inner ring 12 and outer ring 14 and a plurality of stator vanes 16 distributed around the circumference of the stator ring 10 and attached to the inner ring 12 and outer ring 14. As known in the art, each of the stator vanes 16 has an airfoil shape selected to guide airflow across the stator ring 10.

During operation in a gas turbine engine individual stator vanes 16 in the stator ring 10 can wear or otherwise suffer damage that requires repair. While there can be several options for repair individual stator vanes 16 depending on the extent of repair required, one option is to remove the individual stator vane 16 from the stator ring 10 and replace the stator vane 16 with a replacement stator vane 16. The replacement stator vane 16 can be made using PBF techniques. While the specific PBF technique for making a replacement stator vane 16 is outside the scope of this disclosure, a person of ordinary skill will know how to select and implement appropriate PBF techniques to accomplish this task. This disclosure will focus on a method of attaching the replacement stator vane 16 made by PBF techniques to the stator ring 10 using direct energy deposition (DED) process. This combination of AM manufacturing using PBF techniques with AM joining techniques using DED techniques allows the benefits of both techniques to be combined to accomplish a quality repair.

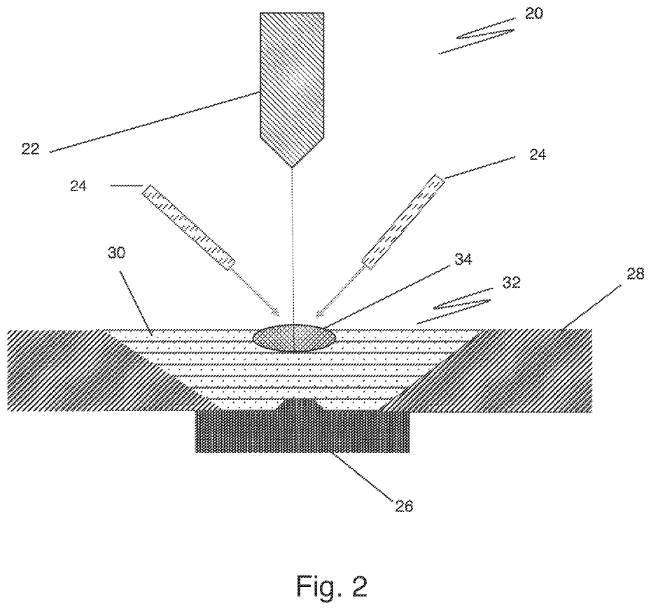

As shown in FIG. 2, DED joining system 20 uses a DED energy source 22 and DED powder distributors 24 to join a PBF replacement feature 26 to an original part 28. Although the process of this disclosure is introduced in the context of joining a replacement stator vane 16 to a stator ring 10 as describe above, FIG. 2 uses a more generic approach to emphasize the broad applicability of the disclosed repair method. As such, the PBF replacement feature 26 and the original part 28 can be any combination of parts for which the disclosed process would be useful. For example, the original part 28 can be a gas turbine engine case (not shown) and the PBF replacement feature 26 can be a boss, flange or other element of a gas turbine engine case that may need to be removed and replaced. A person of ordinary skill will recognize that many other combinations of PBF replacement feature 26 and the original part 28 can be used with the disclosed repair method.

A person of ordinary skill will recognize that the materials used for the PBF replacement feature 26 and the original part 28 can be any of the materials typically used for the applications for which the original part 28 is intended. For example, if the original part 28 is used in a gas turbine application, the base material used to make the original part 28 can be a titanium material for cold section (e.g., compressor) applications (see Table 1 for nonlimiting examples), a superalloy material for hot section (e.g., combustor and turbine) and disk applications (See Table 2 for nonlimiting examples), or specialty steels for other applications (e.g., shafts) (See Table 3 for nonlimiting examples). In most applications, the PBF replacement feature 26 will be made from the same base material as the original part 28 in a powder form that is useable with the PBF technique used to make the PBF replacement feature 26. A person of ordinary skill will recognize that other materials can be used as the base material for the parts and method of this disclosure.

TABLE 1
Selected Titanium Alloys

| Grade designation | Nominal chemical composition |
|---|---|
| Ti64 | Ti—6Al—4V |
| Ti811 | Ti—8Al—1Mo—1V |
| Ti1100 | Ti—6Al—2.8Sn—4Zr—0.4Mo—0.4Si |
| Ti6242 | Ti—6Al—2Sn—4Zr—2Mo |
| Ti6242S | Ti—6Al—2Sn—4Zr—2Mo—0.2Si |

TABLE 2
Selected Superalloys

| Grade designation | Nominal chemical composition |
|---|---|
| Hastelloy X | Ni22Cr1.5Co1.9Fe0.7W9Mo0.07C0.005B |
| IN 100 | 60Ni10Cr15Co3Mo4.7Ti5.5Al0.15C0.015B0.06Zr1.0V |
| IN 625 | 58.8Ni21.5Cr9Mo5Fe3.65Ni0.5Al0.5Ti0.05C0.5Mn0.5Si0.015S0.015P |
| IN 713 | 74.2Ni12.5Cr4.2Mo2Nb0.8Ti6.1Al0.1Zr0.12C0.01B |
| IN 718 | 53Ni19Cr18.5Fe3Mo0.9Ti0.5Al5.1Cb0.03C |
| IN 738 | 61.5Ni16Cr8.5Co1.75Mo2.6W1.75Ta0.9Nb3.4Ti3.4Al0.04Zr0.11C0.01B |
| IN 792 | 60.8Ni12.7Cr9Co2Mo3.9W3.9Ta4.2Ti3.2Al0.1Zr0.21C0.02B |
| Rene 41 | 56Ni19Cr10.5Co9.5Mo3.2Ti1.7Al0.01Zr0.08C0.005B |
| Rene 77 | 53.5Ni15Cr18.5Co5.2Mo3.5Ti4.25Al0.08C0.015B |
| Rene 80 | 60.3Ni14Cr9.5Co4Mo4W5Ti3al0.03Zr0.17C0.015B |
| Rene 80 + Hf | 59.8Ni14Cr9.5Co4Mo4W0.8Hf4.7Ti3Al0.01Zr0.15C0.015B |
| Rene88 DT | 56.4Ni16cr13Co4Mo4W0.7Nb3.7Ti2.1Al0.03C0.015B0.03Zr |
| Rene 95 | 61Ni14Cr8Co3.5Mo3.5W3.5Nb2.5Ti3.5Al0.16C0.01B0.05Zr |
| Rene 100 | 62.6Ni9.5Cr15Co3Mo4.2Ti5.5Al0.06Zr0.15C0.015B |
| MERL-76 | 54.4Ni12.4Cr18.6co3.3Mo1.4Nb4.3Ti5.1Al0.02C0.03B0.35Hf0.06Zr |
| Udimet 720 | 55Ni18Cr14.8Co3Mo1.25W5Ti2.5Al0.035C0.033B0.03Zr |
| Udimet 720LI | 57Ni16Cr15Co3Mo1.25W5Ti2.5Al0.025C0.018B0.03Zr |
| MAR-M200 | 59.5Ni9Cr10Co12.5W1.8Nb2Ti5Al0.05Zr0.15C0.015B |
| MAR-M200 + Hf | Ni8Cr9Co12W2Hf1Nb1.9Ti5.0Al0.03Zr0.13C0.015B |
| MAR-M246 | 59.8Ni9Cr10Co2.5Mo10W1.5Ta1.5Ti5.5Al0.05Zr0.14C0.015B |
| MAR-M246 + Hf | Ni9Cr10Co2.5Mo10W1.5Hf1.5Ta1.5Ti5.5Al0.05Zr0.15C0.015B |
| Udimet 700 | 59Ni14.3Cr14.5Co4.3Mo3.5Ti4.3Al0.02Zr0.08C0.015B |
| Udimet 710 | 54.8Ni18Cr15Co3Mo1.5W2.5Ti5Al0.08Zr0.13C |
| Waspaloy | 58Ni19Cr13Co4Mo3Ti1.4Al |

TABLE 3
Selected Specialty Steels

| Grade designation | Nominal chemical composition |
|---|---|
| CrMoV steel | Fe1Cr0.5Ni1.25Mo0.25V0.30C |
| M152 | Fe12Cr2.5Ni1.7Mo0.3V0.12C |

Continuing with FIG. 2, PBF replacement feature 26 is joined to original part 28 with layers 30 of DED material deposited into the joint 32 between the PBF replacement feature 26 and the original part 28. The DED material is deposited as a powder into the joint 32 using DED powder distributors 24. The DED material can be of any composition deemed suitable to join the PBF replacement feature 26 to the original part 28 and may be the same material as the base material used for the PBF replacement feature 26 to the original part 28. The properties of the DED material powder (e.g., particle size distribution, etc.) can be any such properties consistent with join the PBF replacement feature 26 to the original part 28. The DED layers 30 are formed when DED energy source 22 provides energy to create a melt pool 34 that melts the DED material powder, which later solidifies to form each DED layer 30. The DED energy source 22 can be a laser, an electron beam gun, or any other energy source capable of melting the DED material powder to form the melt pool 34. A person of ordinary skill will know how to select the amount of energy produced by the DED energy source 22 to raise the DED material powder to a temperature sufficient to form the melt pool 34. In addition, a person of ordinary skill will know how to control the DED energy source 22 to raster or scan over the DED material powder to form the melt pool 34 across the length and width of each of the DED layers 30.

During the process described above, no portion of the PBF replacement feature 26 or the original part 28 is subject to melting as would be the case with a weld repair. As a result, use of the DED layers 30 to join the PBF replacement feature 26 to the original part 28 reduces the formation of a heat affected zone (HAZ) in the joint 32 compared to welding or other joining techniques. Reducing or eliminating formation of a HAZ in the joint 32 can lead to less cracking that can result in material failure when the repaired part is placed back into service.

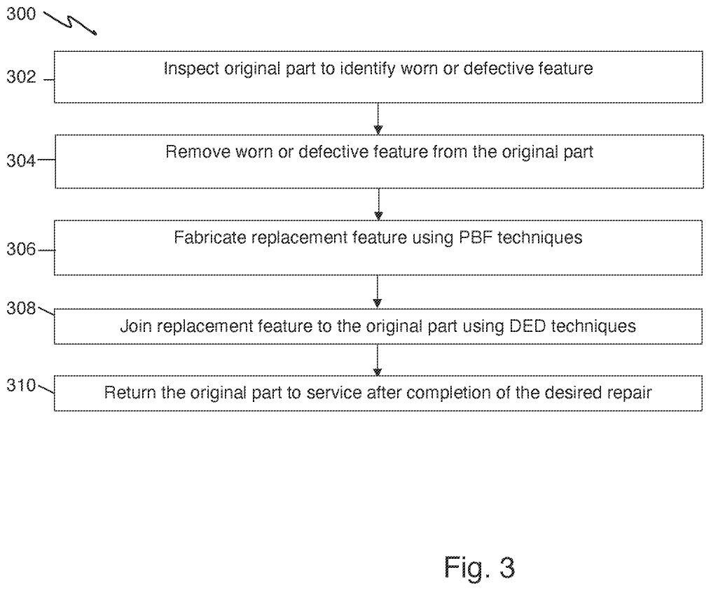

FIG. 3 is a flowchart of the overall repair procedure 300 of this disclosure. At step 302, the original part 28 is inspected to identify whether repair is required and, if so, worn or defective features that need to be replaced. At step 304, the worn or defective features that need to be replaced are removed from the original part. Removal can be accomplished using any appropriate technique including cutting with a saw or abrasive material, wire electro-discharge machining (EDM) techniques or other appropriate removal techniques. At step 306, a replacement feature 26 is made using appropriate techniques, including PBF techniques as described above. At step 308, the replacement feature 26 is joined to the original part 28 using DED joining techniques as described above. Finally, at step 310 the original part is returned to service after completion of the desired repair. A person of ordinary skill will know how to perform each of these steps based upon the present disclosure and knowledge of manufacturing processes.

Using the hybrid repair technique described in this disclosure, i.e., fabricating a replacement feature 26 using PBF techniques and joining the replacement feature 26 to the original part 28 using DED joining techniques, can reduce the scrap rate of the original part 28 by reducing the number of worn or defective features that are outside of allowable repair limits. Rather, replacement features 26 can be fabricated using PBF techniques and joined to the original part 28 without creating an undesirable HAZ in either the replacement feature 26 or original part 28. This result is particularly important if the joint between the replacement feature 26 and original part 28 is located at a “critical” location (i.e., a location at which later part failure can lead to a safety issue or other serious operational issue), such as within a gas flow path in a gas turbine engine.

### Discussion of Possible Embodiments

The following are non-exclusive descriptions of possible embodiments of the present invention.

A method of weld repairing an original part includes inspecting the original part to identify a worn or defective feature requiring repair, removing from the original part the worn or defective feature requiring repair, fabricating a replacement feature, joining the replacement feature to the original part to complete a desired repair, and returning the original part to service after completion of the desired repair. The replacement part is made with a powder beam fusion (PBF) technique. The replacement feature is joined to the original part using a directed energy deposition (DED) joining technique The original part and replacement feature are made from a base material. The DED joining technique uses the base material to join the replacement feature to the original part

The method of the preceding paragraph can optionally include, additionally and/or alternatively, any one or more of the following features, configurations and/or additional elements:

The method of the preceding paragraph, wherein the base material comprises a titanium alloy, a superalloy material, or a specialty steel alloy.

The method of any of the preceding paragraphs, wherein the PBF technique is either PBF-laser or PBF-electron beam.

The method of any of the preceding paragraphs, wherein the DED joining technique uses a laser or electron beam as a DED energy source.

The method of any of the preceding paragraphs, wherein the original part, the worn or defective feature, and the replacement feature are components of a gas turbine engine.

The method of the preceding paragraph, wherein the original part is a stator vane ring and the worn or defective part and the replacement feature are a stator vane.

The method of the preceding paragraph, wherein the original part is a gas turbine engine casing and the worn or defective part and the replacement feature are a boss for a gas turbine engine casing.

An original part repaired using a hybrid repair process comprises the original part made from a base material and a replacement feature made using a powder beam fusion (PBF) technique from the base material, wherein the replacement feature is joined to the original part using a directed energy deposition (DED) joining technique.

The original part of the preceding paragraph can optionally include, additionally and/or alternatively, any one or more of the following features, configurations and/or additional elements:

The original part of the preceding paragraph, wherein the base material comprises a titanium alloy, a superalloy material, or a specialty steel alloy.

The original part of any of the preceding paragraphs, wherein the PBF technique is either PBF-laser or PBF-electron beam.

The original part of any of the preceding paragraphs, wherein the original part and the replacement feature are components of a gas turbine engine.

The original part of the preceding paragraphs, wherein the original part is a stator vane ring and the replacement feature are a stator vane.

The original part of the preceding paragraphs, wherein the original part is a gas turbine engine casing the replacement feature are a boss for a gas turbine engine casing.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of weld repairing an original part, comprising:
inspecting the original part to identify a worn or defective feature requiring repair, wherein the original part is made from a base material;
removing from the original part the worn or defective feature requiring repair;
fabricating, using a powder beam fusion (PBF) technique, a replacement feature, wherein the replacement feature is made from the base material;
joining, using a directed energy deposition (DED) joining technique, the replacement feature to the original part to complete a desired repair, wherein the DED joining technique uses the base material to join the replacement feature to the original part;
returning the original part to service after completion of the desired repair.

2. The method of claim 1, wherein the base material comprises a titanium alloy, a superalloy material, or a specialty steel alloy.

3. The method of claim 1, wherein the PBF technique is either PBF-laser or PBF-electron beam.

4. The method of claim 1, wherein the DED joining technique uses a laser or electron beam as a DED energy source.

5. The method of claim 1, wherein the original part, the worn or defective feature, and the replacement feature are components of a gas turbine engine.

6. The method of claim 5, wherein the original part is a stator vane ring and the worn or defective part and the replacement feature are a stator vane.

7. The method of claim 5, wherein the original part is a gas turbine engine casing and the worn or defective part and the replacement feature are a boss for a gas turbine engine casing.

8. An original part repaired using a hybrid repair process, the original part comprising:
the original part made from a base material; and
a replacement feature made using a powder beam fusion (PBF) technique from the base material, wherein the replacement feature is joined to the original part using a directed energy deposition (DED) joining technique.

9. The part of claim 8, wherein the base material comprises a titanium alloy, a superalloy material, or a specialty steel alloy.

10. The part of claim 8, wherein the PBF technique is either PBF-laser or PBF-electron beam.

11. The part of claim 8, wherein the original part and the replacement feature are components of a gas turbine engine.

12. The part of claim 11, wherein the original part is a stator vane ring and the replacement feature are a stator vane.

13. The part of claim 11, wherein the original part is a gas turbine engine casing the replacement feature are a boss for a gas turbine engine casing.
